(19) United States
(12) Patent Application Publication
(10) Pub. No.: US 2024/0027805 A1
(43) Pub. Date: Jan. 25, 2024

(54) LIQUID CRYSTAL DISPLAY PANEL AND DISPLAY DEVICE

(71) Applicant: WUHAN CHINA STAR OPTOELECTRONICS TECHNOLOGY CO., LTD., Wuhan, Hubei (CN)

(72) Inventor: Chi ZHANG, Wuhan, Hubei (CN)

(21) Appl. No.: 17/292,504

(22) PCT Filed: Apr. 30, 2021
(86) PCT No.: PCT/CN2021/091685

§ 371 Date: May 10, 2021

(30) Foreign Application Priority Data
Apr. 22, 2021 (CN) 202110435325.2

(51) Int. Cl. G02F 1/1333; G02F 1/1335; G02F 1/1337

(52) U.S. Cl. CPC G02F 1/133305; G02F 1/133512; G02F 1/1337

(57) ABSTRACT

The present application discloses a liquid crystal display panel and a display device. The liquid crystal display panel includes a first substrate, a second substrate, and a liquid crystal layer filled between the first substrate and the second substrate. The second substrate includes a supporting column located on a side of the liquid crystal layer. In a location corresponding to the supporting column, a sliding damping structure is disposed on a surface of the first substrate near the liquid crystal layer. Disposing the sliding damping structure on the surface of the first substrate near the liquid crystal layer improves a press resistance capability and a product yield rate of the display panel.

### FIELD OF INVENTION

The present application relates to a field of displays, and especially relates to a liquid crystal display panel and a display device.

### BACKGROUND OF INVENTION

A capability to resist external force pressure of a liquid crystal display (LCD) is an important index for evaluation of LCD quality in industries. An LCD display panel comprises supporting columns for supporting a liquid crystal cell. When the LCD display panel is pressed by an external force, the pressed surface of the display panel would deform. The supporting columns in the liquid crystal cell would slide laterally when receiving the external pressure and would rub against an alignment layer of an array substrate surface to scratch the alignment layer. The greater the pressure applied to the display panel is, the greater an amount of lateral slide of the supporting columns is. The supporting columns sliding laterally to a pixel transmitting region cause scratches to the alignment layer in the pixel transmitting region. The scratched alignment layer cannot effectively perform alignment of liquid crystals, which results in disorder of the liquid crystals in this region. When a light source illuminates the display panel, bright dots appear in this region due to light leakage, which influences a yield rate of the products.

### SUMMARY OF INVENTION

### Technical Issue

The embodiment of the present application provides a liquid crystal display panel and a display device that can increase slide resistance of the supporting columns, reduce an amount of lateral slide of the supporting columns, ease a risk of the supporting columns from sliding and damaging an alignment layer in a pixel light transmitting region, and improve a press resistance capability and a product yield rate of the liquid crystal display panel.

### Technical Solution

The embodiment of the present application provides a liquid crystal display panel, a first substrate, a second substrate, and a liquid crystal layer filled between the first substrate and the second substrate, the second substrate comprising a supporting column located on a side of the liquid crystal layer; and

in a location corresponding to the supporting column, a sliding damping structure is disposed on a surface of the first substrate near the liquid crystal layer.

Optionally, in some embodiments of the present application, the second substrate further comprises a black matrix layer, the black matrix layer is disposed on a side of the supporting column away from the liquid crystal layer, and a projection of the black matrix layer on the first substrate covers the sliding damping structure.

Optionally, in some embodiments of the present application, an area of the projection of the black matrix layer on the first substrate is greater than an area occupied by the sliding damping structure.

Optionally, in some embodiments of the present application, the sliding damping structure comprises recesses and protrusions disposed along a sliding direction in which the supporting column is forced to slide.

Optionally, in some embodiments of the present application, the recesses comprise one or more of annular recesses, mesh grid recesses, circular recesses, or polygonal recesses.

Optionally, in some embodiments of the present application, a projection of a surface border of a side of the supporting column near the first substrate on the first substrate at least partially falls in the recesses.

Optionally, in some embodiments of the present application, the projection of the surface border of the side of the supporting column near the first substrate completely falls in the recesses.

Optionally, in some embodiments of the present application, the sliding damping structure comprises at least one set of the recesses and the protrusions out of a location corresponding to a surface of a side of the supporting column near the first substrate.

Optionally, in some embodiments of the present application, the recesses are defined symmetrically relative to a central line of the supporting column perpendicular to the first substrate.

Optionally, in some embodiments of the present application, a depth of each of the recesses ranges from 0.4 to 0.6 microns.

Optionally, in some embodiments of the present application, a width of each of the recesses ranges from 0.7 to 2.5 microns, a width of each of the protrusions ranges from 0.7 to 2.5 microns.

Optionally, in some embodiments of the present application, the sliding damping structure comprises an organic layer, an alignment layer, and a film layer structure between the organic layer and the alignment layer.

Optionally, in some embodiments of the present application, the recesses are defined in a surface of the organic layer near the liquid crystal layer, and the alignment layer is disposed on a side of the organic layer near the liquid crystal layer.

Accordingly, the embodiment of the present application further provides a display device, comprising a liquid crystal display panel, the liquid crystal display panel comprising a first substrate, a second substrate, and a liquid crystal layer filled between the first substrate and the second substrate, the second substrate comprising a supporting column located on a side of the liquid crystal layer; and

in a location corresponding to the supporting column, a sliding damping structure is disposed on a surface of the first substrate near the liquid crystal layer.

Optionally, in some embodiments of the present application, the second substrate further comprises a black matrix layer, the black matrix layer is disposed on a side of the supporting column away from the liquid crystal layer, and a projection of the black matrix layer on the first substrate covers the sliding damping structure.

Optionally, in some embodiments of the present application, a projection of the supporting column on the first substrate falls in a region in which the sliding damping structure is located.

Optionally, in some embodiments of the present application, the sliding damping structure comprises recesses and protrusions disposed along a sliding direction in which the supporting column is forced to slide.

Optionally, in some embodiments of the present application, the recesses comprise one or more of annular recesses, mesh grid recesses, circular recesses, or polygonal recesses.

Optionally, in some embodiments of the present application, the sliding damping structure comprises an organic layer, an alignment layer, and a film layer structure between the organic layer and the alignment layer, the recesses are defined in a surface of the organic layer near the liquid crystal layer, and the alignment layer is disposed on a side of the organic layer near the liquid crystal layer.

### Advantages

The embodiment of the present application provides a liquid crystal display panel and a display device. The liquid crystal display panel comprises a first substrate, a second substrate, and a liquid crystal layer filled between the first substrate and the second substrate. The second substrate comprises a supporting column located on a side of the liquid crystal layer. In a location corresponding to the supporting column, a sliding damping structure is disposed on a surface of the first substrate near the liquid crystal layer. The liquid crystal display panel, by disposing a sliding damping structure on a surface of the first substrate near the liquid crystal layer, increases the resistance of the support column to slide along the surface of the first substrate when subjected to external pressure, reduces the amount of sliding of the support column, eases a risk of the supporting columns from sliding and damaging an alignment layer in a pixel light transmitting region, and improves a press resistance capability and a product yield rate of the liquid crystal display panel. In the meantime, decreasing a sliding amount of the supporting column is beneficial to decreasing a light shielding amount of the black matrix layer to the supporting column, improves an aperture rate and a transmittance of the liquid crystal display panel, and lowers a cost of a backlight of the liquid crystal display panel.

### DESCRIPTION OF DRAWINGS

Specific embodiments of the present invention are described in details with accompanying drawings as follows to make technical solutions and advantages of the present invention clear.

FIG. 1 is a schematic structural cross-sectional view of a liquid crystal display panel provided by an embodiment of the present application.

FIG. 2 is a first structural schematic plan view of the liquid crystal display panel provided by the embodiment of the present application.

FIG. 3 is a second structural schematic plan view of the liquid crystal display panel provided by the embodiment of the present application.

FIG. 4 is a third structural schematic plan view of the liquid crystal display panel provided by the embodiment of the present application.

### DETAILED DESCRIPTION OF PREFERRED EMBODIMENTS

An embodiment of the present application provides a liquid crystal display panel and a display device, to increase slide resistance of the supporting columns, reduce an amount of lateral slide of the supporting columns, ease a risk of the supporting columns from sliding and damaging an alignment layer in a pixel light transmitting region, and improve a press resistance capability and a product yield rate of the liquid crystal display panel, which will be described in details as follows. It should be explained that the description order of the following embodiments is not a limitation on the preferred order of the embodiments.

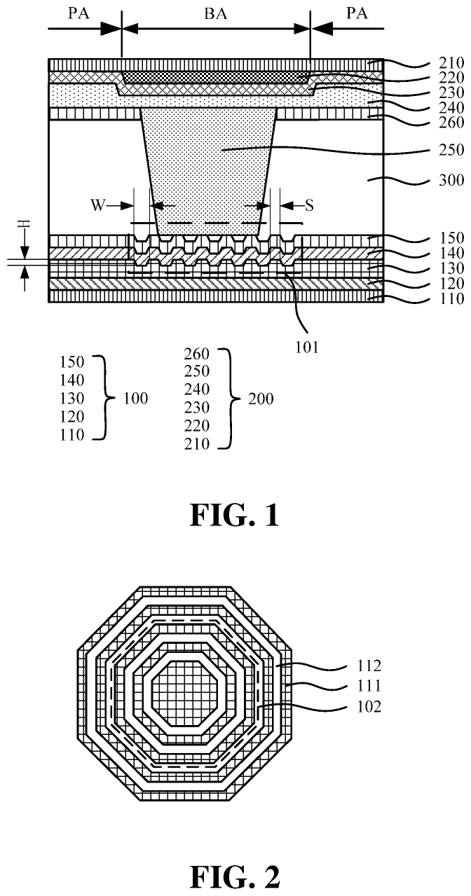

In an embodiment, with reference to FIG. 1, FIG. 1 is a schematic structural cross-sectional view of a liquid crystal display panel provided by an embodiment of the present application. As shown in the figure, a liquid crystal display panel provided by the embodiment of the present application comprises a first substrate 100, a second substrate 200, and a liquid crystal layer 300 filled between the first substrate 100 and the second substrate 200. The second substrate 200 comprises a supporting column 250 located on a side of the liquid crystal layer 300. In a location corresponding to the supporting column 250, a sliding damping structure 101 is disposed on a surface of the first substrate 100 near the liquid crystal layer 300.

The embodiment of the present application provides a liquid crystal display panel. The liquid crystal display panel, by disposing a sliding damping structure on a surface of the first substrate near the liquid crystal layer, increases the resistance of the support column to slide along the surface of the first substrate when subjected to external pressure, reduces the amount of sliding of the support column, eases a risk of the supporting columns from sliding and damaging an alignment layer in a pixel light transmitting region, and improves a press resistance capability and a product yield rate of the liquid crystal display panel.

Specifically, with reference to FIG. 1, the first substrate 100 is an array substrate and comprises a first underlay 110, a first array layer 120, an organic layer 130, a second array layer 140, and a first alignment layer 150 stacked on one another from bottom to top.

The first underlay 110 is generally a transparent rigid underlay, for example a transparent glass.

The first array layer 120 generally comprises a semiconductor active layer, a first insulation layer, a first gate electrode layer, a second insulation layer, a second gate electrode layer, a third insulation layer, and a source and drain electrode layer stacked on one another from bottom to top. The semiconductor active layer, the first gate electrode layer, the second gate electrode layer and the source and drain electrode layer cooperatively form devices such as a thin film transistor and a capacitor of the liquid crystal display panel. The semiconductor active layer is patterned to form an active region of the thin film transistor. The active region comprises a channel region and a doping region on two sides of the channel region. Material of the semiconductor active layer 121 can be oxide semiconductor material, and can be polycrystalline silicon material or monocrystalline silicon material, which is not limited here. The first gate electrode layer is patterned to form a first gate electrode of the thin film transistor and a first electrode plate of the capacitor. The second gate electrode layer is patterned to form a second gate electrode of the thin film transistor and a second electrode plate of the capacitor. Both the first gate electrode and the second gate electrode correspond to the channel region of the active layer. The source and drain electrode layer is patterned to form a source electrode and a drain electrode of the thin film transistor, and the source electrode and the drain electrode extend through via holes of the first insulation layer, the second insulation layer, and the third insulation layer to connect with the doping region on the two sides of the channel region. The thin film transistor and the capacitor, and a signal line in the array substrate 100 cooperatively form a driver circuit of the display panel configured to drive liquid crystals of the liquid crystal layer 300 to rotate. The first insulation layer is disposed between the semiconductor active layer and the first gate electrode layer. The second insulation layer is disposed between the first gate electrode layer and the second gate electrode layer. The third insulation layer is disposed between the second gate electrode layer and the source and drain electrode layer. The first insulation layer, the second insulation layer, and the third insulation layer are configured to insulate two conductive layers adjacent thereto. In the liquid crystal display panel provided by the embodiment of the present application, the first array layer 120 can also be a structure known by a person of ordinary skill in the art. The above structure of the first array layer 120 is only for explanation of the structure of the display panel provided by the embodiment of the present application, and is not construed as a limitation.

The organic layer 130 is a planarization layer, is formed on the source and drain electrode layer, and is configured to planarize the first array layer 120 for providing a planar base for manufacturing a second array layer 140 on the organic layer 130. Material of the planarization layer mainly includes acrylic acid series organic material and siloxane series organic material, and specifically includes but is not limited to organic material such as acrylic, polyimide, or benzocyclobutene. A thickness of the organic layer 130 ranges from 2-3 microns.

The second array layer 140 is formed on the organic layer 130 and is generally an electrode layer. When the liquid crystal display panel is a twisted nematic (TN) type liquid crystal display panel or a vertical alignment (VA) type liquid crystal display panel, the second array layer 140 is a first electrode layer. The first electrode layer is patterned to form individual first electrodes disposed at intervals. Each of the first electrode penetrates a via hole of the planarization layer 130 to connect with a source electrode or a drain electrode of a thin film transistor below to further connect with the driver circuit of the liquid crystal display panel. The second substrate 200 comprises a second electrode layer corresponding to the first electrode layer. When the liquid crystal display panel is an in-plane switching (IPS) type liquid crystal display panel, the second array layer 140 is an electrode layer. The electrode layer comprises first electrodes and second electrodes. Similarly, each of the first electrodes penetrates a via hole of the planarization layer 130 to connect with the source electrode or the drain electrode of the thin film transistor below to connect with the driver circuit of the liquid crystal display panel. When the liquid crystal display panel is a fringe field switching (FFS) type liquid crystal display panel, the second array layer 140 comprises a first layer electrode layer, a second electrode layer, and an insulation layer located between the first electrode layer and the second electrode layer. Similarly, the first electrode layer is patterned to form individual first electrodes disposed at intervals. Each of the first electrodes penetrates a via hole of the planarization layer 130 to connect with the source electrode or the drain electrode of the thin film transistor below to connect with the driver circuit of the liquid crystal display panel. A thickness of the second array layer 140 is controlled at about 0.3 microns.

The first alignment layer 150 is formed on the second array layer 140, and is configured to align liquid crystal molecules in the liquid crystal layer 300 to control arrangement of the liquid crystal molecules. Material of the first alignment layer 150 is organic polymer material, and is generally polyimide (PI). A thickness of the first alignment layer 150 ranges from 500-800 Å.

The second substrate 200 is a color filter substrate, and comprises a second underlay 210, a black matrix layer 220, a color filter layer 230, a planarization layer 240, the supporting column 250, and a second alignment layer 260 stacked on one another from top to bottom.

The second underlay 210 is similar to the first underlay 110, and is generally a transparent rigid underlay such as transparent glass.

The black matrix layer 220 is formed under the second substrate, and is patterned to form color resist apertures at intervals. The color resist apertures correspond to pixel light transmitting regions PA of the liquid crystal display panel. A location where the patterned black matrix layer 220 is situated corresponds to a light shielding region BA of the liquid crystal display panel. Material of the black matrix layer 220 is generally a black resin doped with black pigments and is configured to shield light between adjacent pixels to prevent color mix of the connected color filter layer to improve contrast of the liquid crystal display panel, reduce reflection of external light, and reduce low blue light effect, as well as prevent increase of leakage current due to irradiation of external light on the channel of the thin film transistor.

The color filter layer 230 is formed under the black matrix layer 220 and comprises a red color resist layer, a blue color resist layer, and a green color resist layer disposed on the same layer. The red color resist layer, the blue color resist layer, and the green color resist layer cover different color resist apertures, and are configured to transmit light with color the same as that of the color resist layer thereof and to shield light with different colors therefrom. Material of the color resist layer generally includes pigments corresponding to its colors, photocurable resin, alkaline soluble resin, photo-initiators, etc.

The planarization layer 240 is formed under the color filter layer 230, and is configured to protect the color filter layer 230 and to realize planarization of a surface of the second substrate 200 simultaneously. Material of the planarization layer 240 mainly comprises acrylic acid series organic material and siloxane series organic material, and specifically comprises but is not limited to organic material such as acrylic, polyimide, or benzocyclobutene.

The supporting column 250 is formed under the planarization layer 240, is located in the light shielding region BA, and is configured to support the first substrate 100 and the second substrate 200 to maintain uniformity of the cell thickness of the liquid crystal display panel. Main material of the supporting column 250 is acrylic resin. Usually, an end of the supporting column 250 is located on the second substrate 200, another end thereof contacts the first substrate 100, namely, contacts the first alignment layer 150 of the first substrate 100.

The second alignment layer 260 is formed under the planarization layer 240, and is configured align the liquid crystal molecules in the liquid crystal layer 300 to control arrangement of the liquid crystal molecules. Material of the second alignment layer 260 is organic polymer material, and is generally polyimide. The second alignment layer 260 and the first alignment layer 150 make alignment directions of the liquid crystal molecules perpendicularly intersected.

In an embodiment, with reference to FIG. 1, the sliding damping structure 101 is formed on the surface of the first substrate 100 near the liquid crystal layer 300. The sliding damping structure 101 is located in the light shielding region BA and corresponds to the supporting column 250. Furthermore, an edge of the sliding damping structure 101 can be non-coincident with an edge of the light shielding region BA. The sliding damping structure 101 prevents influence of the sliding damping structure 101 to alignment of the liquid crystal molecules of the pixel light transmitting region PA while increasing a slide resistance of the supporting column 250 on the first substrate 100. Furthermore, decreasing a sliding amount of the supporting column 250 is beneficial to decreasing a light shielding amount of the black matrix layer 220 to the supporting column 250. Namely, a range of a width of the black matrix layer 220 can be reduced accordingly, and color resist apertures can be increased accordingly, which facilitates improvement of an aperture rate and a transmittance of the liquid crystal display panel, and reduces cost of a backlight of the liquid crystal display panel.

In an embodiment, with reference to FIGS. 1 to 4, the sliding damping structure 101 is a recess-protrusion structure disposed on the surface of the first substrate 100 near the supporting column 250 in a sliding direction along which the supporting column 250 is forced to slide. In an embodiment, with reference to FIG. 1, the recess-protrusion structure is formed by three film layer structures on the first substrate 100, and is specifically formed by the organic layer 130, the second array layer 140, and the first alignment layer 150. Specifically, in the light shielding region BA, recesses are defined in a surface of the organic layer 130 near the liquid crystal layer 300 at a location corresponding to the supporting column 250, a depth H of each of the recesses ranges from 0.4-0.6 microns, a width W of each of the recesses ranges from 0.7 to 2.5 microns, and a width S of each of the protrusions between adjacent recesses ranges from 0.7 to 2.5 microns. Because a thickness of the organic layer 130 is in a range from 2 to 3 microns, the surface of the organic layer 130 has an uneven structure under the circumstance of no influence of the disposed recesses to the organic layer 130. The recesses in the organic layer 130 can be obtained by a patterning process. The patterning method can be realized by changing a mask plate in the organic layer process on the basis of the existing process, without the need to increase the number of masks or change the process, which saves the production steps and reduces a production cost. A specific patterning processing method can be learned from the processing methods well-known by a person of ordinary skill in the art, and will not be described repeatedly here. Because the structure of the recesses is disposed on the surface of the organic layer 130 near the liquid crystal layer 300, a location of the recesses of the organic layer 130 would also form a structure of recesses when the second array layer 140 is formed on the organic layer 130. With reference to FIG. 1, because a depth H of each of the recesses of the organic layer ranges from 0.4-0.6 microns, a width W of each of the recesses ranges from 0.7 to 2.5 microns, a width S of the protrusion between two adjacent recesses ranges from 0.7 to 2.5 microns, and a thickness of the second array layer 140 is about 0.3 microns, therefore, the second array layer 140 also forms a recess structure with the same shape and size. Similarly, when the first alignment layer 150 is formed on the second array layer 140, the first alignment layer 150 also forms a recess structure with the same shape and size. As such, the organic layer 130, the second array layer 140, and the first alignment layer 150 sequentially stacked on one another commonly form the recess-protrusion structure. Namely, the sliding damping structure 101 is formed on the first substrate 100 near the supporting column 250.

In an embodiment, with reference to FIGS. 2 to 4, a region in which the sliding damping structure 101 is located is larger than a region 102 (the region surrounded by a broken line in the figure) that the supporting column 250 and the first substrate 100 contacts or a projection region 102 (the region surrounded by a broken line in the figure) of the supporting column 250 on the first substrate 100. Furthermore, the region in which the sliding damping structure 101 is located comprises the projection region of the supporting column 250 on the first substrate 100. Moreover, out of the region 102, the sliding damping structure 101 further comprises at least one set of recesses and protrusions to guarantee sufficient sliding damping structures along a sliding direction to provide slide resistance when the supporting column 250 is subjected to an external force to slide. In the liquid crystal display panel provided by the embodiment of the present application, the supporting column 250 is a columnar supporting structure, and is generally a regular columnar structure, and can be cylindrical, and can also be poly-prismatic. The embodiment of the present application uses the hexagonal prismatic as an example to describe the display panel provided by the embodiment of the present application in detail with reference to the drawings.

In an embodiment, with reference to FIG. 2, the recesses 112 of the sliding damping structure 101 are annular recesses. Preferably, the annular recesses 112 are defined symmetrically relative the central line of the supporting column 250 as a center. The annular recesses 112 comprise a plurality of concentric annular recesses disposed at intervals. Shapes of an outer periphery and an inner periphery of each of the annular recesses are the same as a shape of an outer periphery of the supporting column 250 and are hexagonal. An inner radius and an outer radius of each of the annular recesses are different, a width of each of the annular recesses 112 ranges from 0.7 to 2.5 microns. A width of a protrusion 111 between two adjacent annular recesses 112 ranges from 0.7 to 2.5 microns. The present embodiment, by disposing the annular sliding damping structure on the surface of the first substrate 100 near the supporting column 250, guarantees that each location of a surface of the supporting column 250 contacting the first substrate 100 is blocked by the annular sliding damping structure when the supporting column 250 is subjected to an external pressure and slides relative to the surface of the first substrate 100 such that a sliding action of the supporting column 250 relative to the first substrate 100 along any direction is subjected a greater resistance, which blocks the sliding action of the supporting column 250 relative to the surface of the first substrate 100, reduces a sliding amount of the supporting column 250 on the surface of the first substrate 100, eases a risk of the supporting column 250 from sliding to the pixel light transmitting region PA and damaging the first alignment layer 150 in the pixel light transmitting region PA, and improves a press resistance capability and a product yield rate of the liquid crystal display panel. With reference to FIG. 2, the annular recesses 112 not only comprise annular recesses in the region 102 corresponding to the supporting column 250, but also comprise annular recesses out of the region 102 corresponding to the supporting column 250, which guarantees a greater range of disposing the recess-protrusion structure, improves a slide resistance of the supporting column 250 relative to a surface of the first substrate 100 to a greater extent, more effectively decreases a sliding amount of the supporting column 250 relative to the surface of the first substrate 100, eases a risk of the supporting columns from sliding and damaging the first alignment layer 150 in the pixel light transmitting region PA, and improves a press resistance capability and a product yield rate of the liquid crystal display panel. In the liquid crystal display panel provided by the present embodiment, annular recesses 112 can also be circular, quadrilateral, dodecagonal annular recesses, which is not limited here. In the liquid crystal display panel provided by the present embodiment, the annular recesses 112 can also be disposed asymmetrically relative to the central line of the supporting column 250, which is not limited here.

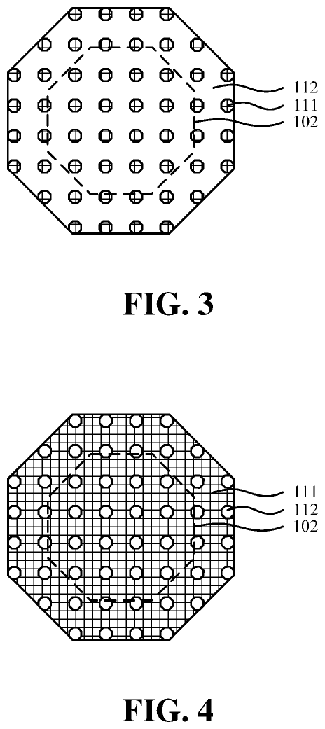

In another embodiment, with reference to FIG. 3, the recesses 112 of the sliding damping structure 101 are mesh grid recesses. Preferably, the mesh grid recesses 112 are defined symmetrically according to the central line of the supporting column 250 as the center. A region in which the mesh grid recesses 112 are located comprises and is greater than a region 102 corresponding to the supporting column 250. Regions surrounded by the mesh grid recesses 112 form protrusions 111. A shape of each of the protrusions 111 can be the same hexagonal as the supporting column 250, and can be circular or polygonal. Sizes of all the protrusions 111 can be the same, and at least two protrusions 111 with different shapes or sizes can exist. A width of each of the protrusions 111 ranges from 0.7 to 2.5 microns, and a width of each of the mesh grid recesses 112 ranges from 0.7 to 2.5 microns. The present embodiment, by disposing the grid type sliding damping structure on the surface of the first substrate 100 near the supporting column 250, guarantees that the supporting column 250 is blocked by the grid type sliding damping structure when subjected to an external pressure and sliding relative to the surface of the first substrate 100 such that a sliding action of the supporting column 250 relative to the first substrate 100 is subjected to a greater resistance, which blocks the sliding action of the supporting column 250 relative to the surface of the first substrate 100, reduces a sliding amount of the supporting column 250 on the surface of the first substrate 100, eases a risk of the supporting column 250 from sliding to the pixel light transmitting region PA and damaging the first alignment layer 150 in the pixel light transmitting region PA, and improves a press resistance capability and a product yield rate of the liquid crystal display panel.

In still another embodiment, the recesses 112 of the sliding damping structure 101 are circular or polygonal recesses at intervals. With reference to FIG. 4, a plane shape of each of the recesses 112, the same as the supporting column 250, is hexagonal. Preferably, the hexagonal recesses 112 are defined symmetrically relative to the central line of the supporting column 250. A region occupied by hexagonal recesses 112 comprises and is greater than the region 102 corresponding to the supporting column 250. Regions between adjacent hexagonal recesses 112 form protrusions 111. In an embodiment solution, sizes of all the hexagonal recesses 112 are the same. In another embodiment solution, at least two hexagonal recesses 112 with different sizes exist. In an embodiment solution, a distance between any two adjacent hexagonal recesses 112 is equal. In another embodiment solution, at least two adjacent hexagonal recesses 112 exits, and the distance between any two adjacent hexagonal recesses 112 is not equal. A width of each of the hexagonal recesses 112 ranges from 0.7 to 2.5 microns. A width of each of the protrusions 111 ranges from 0.7 to 2.5 microns. In the liquid crystal display panel provided by the present embodiment, at least two different recesses can exit, and the two recesses have different shapes, which is not limited here. The present embodiment, by disposing a sliding damping structure including individual recesses on the surface of first substrate 100 near the supporting column 250, guarantees that the supporting column 250 is blocked by the sliding damping structure when subjected to an external pressure and sliding relative to the surface of the first substrate 100 such that a sliding action of the supporting column 250 relative to the first substrate 100 is subjected to a greater resistance, which blocks the sliding action of the supporting column 250 relative to the surface of the first substrate 100, reduces a sliding amount of the supporting column 250 on the surface of the first substrate 100, eases a risk of the supporting column 250 from sliding to the pixel light transmitting region PA and damaging the first alignment layer 150 in the pixel light transmitting region PA, and improves a press resistance capability and a product yield rate of the liquid crystal display panel.

In other embodiment, the recesses 112 of the sliding damping structure 101 can further comprise at least two of annular recesses, mesh grid recesses, or polygonal/circular recesses.

Accordingly, the embodiment of the present application further provides a display device, the display device comprises any one of the liquid crystal display panels provided by the embodiment of the present application, and comprises technical features and technical effects of any one of the liquid crystal display panels provided by the embodiment of the present application. For specific implementation and working principle, please refer to the above specific embodiment, which will not be repeated here.

As described above, the embodiment of the present application provides a liquid crystal display panel and a display device. The liquid crystal display panel comprises a first substrate, a second substrate, and a liquid crystal layer filled between the first substrate and the second substrate. The second substrate comprises a supporting column located on a side of the liquid crystal layer. In a location corresponding to the supporting column, a sliding damping structure is disposed on a surface of the first substrate near the liquid crystal layer. The liquid crystal display panel, by disposing a sliding damping structure on a surface of the first substrate near the liquid crystal layer, increases the resistance of the support column to slide along the surface of the first substrate when subjected to external pressure, reduces the amount of sliding of the support column, eases a risk of the supporting columns from sliding and damaging an alignment layer in a pixel light transmitting region, and improves a press resistance capability and a product yield rate of the liquid crystal display panel. In the meantime, decreasing a sliding amount of the supporting column is beneficial to decreasing a light shielding amount of the black matrix layer to the supporting column, improves an aperture rate and a transmittance of the liquid crystal display panel, and lowers a cost of a backlight of the liquid crystal display panel.

The liquid crystal display panel and the display device provided by the embodiment of the present application are described in detail as above. In the specification, the specific examples are used to explain the principle and embodiment of the present application. The above description of the embodiments is only used to help understand the method of the present application and its spiritual idea. Meanwhile, for those skilled in the art, according to the present the idea of invention, changes will be made in specific embodiment and application. In summary, the contents of this specification should not be construed as limiting the present application.

What is claimed is:

1. A liquid crystal display panel, comprising a first substrate, a second substrate, and a liquid crystal layer filled between the first substrate and the second substrate, the second substrate comprising a supporting column located on a side of the liquid crystal layer; and
wherein in a location corresponding to the supporting column, a sliding damping structure is disposed on a surface of the first substrate near the liquid crystal layer.

2. The liquid crystal display panel according to claim 1, wherein the second substrate further comprises a black matrix layer, the black matrix layer is disposed on a side of the supporting column away from the liquid crystal layer, and a projection of the black matrix layer on the first substrate covers the sliding damping structure.

3. The liquid crystal display panel according to claim 2, wherein an area of the projection of the black matrix layer on the first substrate is greater than an area occupied by the sliding damping structure.

4. The liquid crystal display panel according to claim 2, wherein a projection of the supporting column on the first substrate falls in a region in which the sliding damping structure is located.

5. The liquid crystal display panel according to claim 1, wherein the sliding damping structure comprises recesses and protrusions disposed along a sliding direction in which the supporting column is forced to slide.

6. The liquid crystal display panel according to claim 5, wherein the recesses comprise one or more of annular recesses, mesh grid recesses, circular recesses, or polygonal recesses.

7. The liquid crystal display panel according to claim 6, wherein a projection of a surface border of a side of the supporting column near the first substrate on the first substrate at least partially falls in the recesses.

8. The liquid crystal display panel according to claim 7, wherein the projection of the surface border of the side of the supporting column near the first substrate completely falls in the recesses.

9. The liquid crystal display panel according to claim 5, wherein the sliding damping structure comprises at least one set of the recesses and the protrusions out of a location corresponding to a surface of a side of the supporting column near the first substrate.

10. The liquid crystal display panel according to claim 5, wherein the recesses are defined symmetrically relative to a central line of the supporting column perpendicular to the first substrate.

11. The liquid crystal display panel according to claim 5, wherein a depth of each of the recesses ranges from 0.4 to 0.6 microns.

12. The liquid crystal display panel according to claim 5, wherein a width of each of the recesses ranges from 0.7 to 2.5 microns, and a width of each of the protrusions ranges from 0.7 to 2.5 microns.

13. The liquid crystal display panel according to claim 5, wherein the sliding damping structure comprises an organic layer, an alignment layer, and a film layer structure between the organic layer and the alignment layer.

14. The liquid crystal display panel according to claim 13, wherein the recesses are defined in a surface of the organic layer near the liquid crystal layer, and the alignment layer is disposed on a side of the organic layer near the liquid crystal layer.

15. A display device, comprising a liquid crystal display panel, the liquid crystal display panel comprising a first substrate, a second substrate, and a liquid crystal layer filled between the first substrate and the second substrate, the second substrate comprising a supporting column located on a side of the liquid crystal layer; and
wherein in a location corresponding to the supporting column, a sliding damping structure is disposed on a surface of the first substrate near the liquid crystal layer.

16. The display device according to claim 15, wherein the second substrate further comprises a black matrix layer, the black matrix layer is disposed on a side of the supporting column away from the liquid crystal layer, and a projection of the black matrix layer on the first substrate covers the sliding damping structure.

17. The display device according to claim 16, wherein a projection of the supporting column on the first substrate falls in a region in which the sliding damping structure is located.

18. The display device according to claim 15, wherein the sliding damping structure comprises recesses and protrusions disposed along a sliding direction in which the supporting column is forced to slide.

19. The display device according to claim 18, wherein the recesses comprise one or more of annular recesses, mesh grid recesses, circular recesses, or polygonal recesses.

20. The display device according to claim 18, wherein the sliding damping structure comprises an organic layer, an alignment layer, and a film layer structure between the organic layer and the alignment layer, the recesses are defined in a surface of the organic layer near the liquid crystal layer, and the alignment layer is disposed on a side of the organic layer near the liquid crystal layer.
